(19) United States
(12) Patent Application Publication
(10) Pub. No.: US 2009/0221089 A1
(43) Pub. Date: Sep. 3, 2009

(54) PROBE CHIP, SENSING APPARATUS USING THE SAME AND METHOD OF DETECTING SUBSTANCES USING THE SAME

(75) Inventor: Toshihito KIMURA, Ashigara-kami-gun (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 12/391,681

(22) Filed: Feb. 24, 2009

(30) Foreign Application Priority Data
Feb. 28, 2008 (JP) 2008-048119

(51) Int. Cl. G01N 21/64

(52) U.S. Cl. 436/172; 422/82.08

(57) ABSTRACT

A probe chip comprises: a prism; a metal film provided on a surface of the prism and which has provided on its surface a first binding material that binds to the analyte; and a channel substrate that is provided on a side of the prism and which has formed therein a channel for supplying the liquid sample to the metal film by causing the liquid material to travel from a beginning end portion to a terminal end portion, the channel being formed in such a way that a zone from a point between the beginning end portion and the metal film to a position of contact with the metal film separates into a first branch and a second branch that has an area where a second binding material that is labeled with the fluorescent material and which binds to the analyte is placed.

The entire contents of all documents cited in this specification are incorporated herein by reference.

### BACKGROUND OF THE INVENTION

The present invention relates to a probe chip for use in detecting an analyte in liquid samples with the aid of an enhanced field created by allowing light to strike a metal film at a specified incident angle, as well as a sensing apparatus using the probe chip, and a method of detecting substances with the aid of an enhanced field created by allowing light to strike a metal film at a specified angle of incidence.

Known as a method that can be used in bio-measurement (measurement of reactions in biomolecules) and the like to detect (or measure) the analyte with high sensitivity and great ease is fluorometry in which fluorescence from a fluorescent material that is excited by light at a specified wavelength to emit fluorescence (i.e., a fluorescence emitting material) is detected to thereby detect (or measure) the analyte.

If the analyte in fluorometry is a fluorescent material, a sample of interest that is assumed to contain the analyte is irradiated with exciting light at a specified wavelength and the resulting emission of fluorescence is detected to verify the presence of the analyte.

In fact, the analyte is not usually a fluorescent material but even in this case, a specifically binding material, or a material that specifically binds to the analyte is labeled with a fluorescent material and then bound to the analyte; subsequently, the same procedure as described above is performed to detect fluorescence (specifically, the fluorescence from the fluorescent material with which the specifically binding material that has bound to the analyte is labeled), whereby the presence of the analyte is verified.

It has been proposed that the sensitivity of analyte detection in fluorometry be increased by exciting the fluorescent material with the aid of an enhanced electric field that results from surface plasmon resonance on a metal film (see, for example, JP 2002-62255 A, JP 2001-21565 A, and JP 2002-257731 A).

In each of the methods described in those patent documents, an analyte labeled with a fluorescent material is positioned in the neighborhood of a thin metal film and light is allowed to strike the boundary surface between the thin metal film and a prism (either a semicylindrical or triangular glass prism) at an angle that satisfies the plasmon resonance condition (plasmon resonance angle) to create an enhanced electric field on the thin metal film so that the analyte in the neighborhood of the thin metal film is excited strong enough to amplify the emission of fluorescence from the fluorescent material. This is a method of fluorescence detection utilizing the surface plasmon enhanced fluorescence (which is hereinafter sometimes abbreviated as SPF).

As described in JP 2001-21565 A, the electric field of surface plasmons is highly localized on the metal surface and attenuates exponentially with the distance from the metal surface, so fluorescently labeled antibodies (i.e., the fluorescent material) adsorbed onto the metal surface can be excited selectively and with high probability. As also described in JP 2001-21565 A, this SPF-based version of fluorescence detection ensures that the effect of any interfering material that is distant from the interface is suppressed to the smallest level, which also allows for precise detection of the analytes.

### SUMMARY OF THE INVENTION

A problem with the detection of fluorescence from the fluorescent material in fluorometry is that the measured value includes extraneous light other than the fluorescence from the fluorescent material, as exemplified by endogenous fluorescence from various parts of the detector system such as the container, the liquid sample and the optical unit, the exciting light from the metal film that has passed through the filter in the light receiving optical unit without being cut off, and the electric noise from the sensing unit.

To deal with this problem of fluorometry, those noise components are cut off by baseline subtraction. Specifically, the fluorescence that is emitted before the analyte labeled with the fluorescent material is positioned on the metal film (which is hereinafter sometimes referred to as the detection surface) is measured as detection signal P0 whereas the fluorescence emitted after the analyte is positioned on the detection surface is measured as detection signal P, and a difference Δ=P−P0 is detected as a noise-free fluorescence signal from the fluorescent material with which the analyte is labeled.

Generally speaking, the detection surface at the time when P0 is measured (i.e., before the analyte is positioned on the detection surface) is in contact with the air only whereas the detection surface at the time when P is measured (i.e., as the analyte labeled with the fluorescent material is positioned on the detection surface) is filled with the liquid sample. In addition, the refractive index of the detection surface varies greatly depending on whether it has a liquid on it or not, so the refractive index of the detection surface changes a lot between the measurements of P0 and P and the difference dₙ may be as great as 0.3.

A further problem with the SPF-based method of detecting fluorescence is that the plasmon resonance condition and, hence, the plasmon resonance angle vary with the refractive index at the surface of the thin metal film; this means that a great change in the refractive index at the surface of the thin metal film is accompanied by a correspondingly great change in the plasmon resonance angle.

Accordingly, the plasmon resonance angle changes a lot between the measurements of P0 and P. For example, if the refractive index changes by 0.3, the plasmon resonance angle varies by about 20 degrees.

As a result, even if light of the same wavelength is allowed to be incident at the same angle in the measurements of P0 and P, no plasmon resonance occurs, nor does the enhancing effect of surface plasmons. Thus, baseline subtraction that is performed on the basis of P0 and P measurements made under the same conditions is incapable of correct noise removal since the intensity of the enhanced electric field created on the metal film is different and so is the state of light emission.

The enhancing effect of surface plasmons can be created by changing the incident angle and wavelength of the exciting light between the measurements of P0 and P but, then, a system configuration that enables the incident angle and wavelength of the exciting light to be adjusted in accordance with the variation in refractive index results in a complex and expensive apparatus.

As a further problem, given the great difference in plasmon resonance angle, changes in the wavelength and incident angle will cause a corresponding change in noise and, obviously, baseline subtraction that is performed on the basis of P0 and P measurements made under different conditions is incapable of correctly removing the noise as occurs during the measurement.

As mentioned above, baseline subtraction cannot be performed if the detection surface remains dry during P0 measurement, so one might think of wetting the detection surface with a buffer solution before starting the P0 measurement. However, the buffer solution is a cost increasing factor. What is more, a refractive index difference between the buffer solution and the liquid sample containing the analyte again causes a change in the plasmon resonance condition and, hence, in the degree by which the emission of fluorescence is enhanced; this lack of quantitativeness makes it impossible to achieve correct noise removal.

As a further problem, noise varies with a number of factors including the type of the sample, its state, concentration, the thickness of the thin metal film, and the shape of the prism, so it is impossible to correctly remove the noise as occurs during the measurement even if data on the preliminarily measured sample is used.

These problems are in no way limited to the case of detecting the analyte with the aid of an electric field created by surface plasmons; similar problems occur when the analyte is to be detected using an enhanced field that is created by allowing light to strike the detection surface at a specified angle of incidence.

An object, therefore, of the present invention is to solve the aforementioned problems with the prior art by providing a probe chip that enables correct baseline subtraction to ensure that the analyte in a liquid sample is detected with high precision.

Another object of the present invention is to provide a sensing apparatus that uses the probe chip.

A further object of the present invention is to provide a method of detecting substances with the probe chip.

A probe chip according to the invention comprises: a prism; a metal film provided on a surface of the prism and which has provided on its surface a first specifically binding material that specifically binds to the analyte; and a channel substrate that is provided on a side of the prism and which has formed therein a channel for supplying the liquid sample to the metal film by causing the liquid material to travel from a beginning end portion to a terminal end portion, the channel being formed in such a way that a zone from a point between the beginning end portion and the metal film to a position of contact with the metal film separates into a first branch and a second branch that has an area where a second specifically binding material that is labeled with the fluorescent material and which specifically binds to the analyte is placed; wherein the liquid sample traveling through the first branch is caused to reach the metal film, after which the liquid sample traveling through the second branch is caused to reach the metal film.

A sensing apparatus according to the invention comprises: a light source for issuing light; a prism; a metal film provided on a surface of the prism and which has provided on its surface a first specifically binding material that specifically binds to the analyte; a sample holder by which the liquid dripped over the metal film is held on the metal film; an optical unit for incident light by which the light issued from the light source is launched into the prism at such an angle that it is totally reflected on a boundary surface between the prism and the metal film; a light detecting means that is provided in a face-to-face relationship with that surface of the metal film that is away from the prism for detecting light that is generated in neighborhood of the metal film; a first receptacle for containing the liquid sample; a second receptacle for containing a second specifically binding material that is labeled with the fluorescent material and which specifically binds to the analyte; a dispensing means for dispensing the liquid sample on the metal film; and a control means that controls the operations of the light detecting means and the dispensing means; wherein the control means causes the dispensing means to dispense the liquid sample in the first receptacle on the metal surface and also causes the light detecting means to detect the light generated in neighborhood of the metal film on which the liquid sample in the first receptacle has been dispensed, after which the control means causes the dispensing means to dispense the liquid sample into the second receptacle, mix the liquid sample with the second specifically binding material to obtain a mixture and dispense the mixture on the metal film, and also causes the light detecting means to detect the light generated in neighborhood of the metal film on which the mixture has been dispensed.

A method of detecting substances according to the invention comprising: a metal film providing step in which a metal film having on a surface thereof a specifically binding material that specifically binds to an analyte is provided; a first liquid sample feeding step in which a liquid sample that is not labeled with the fluorescent material is brought into contact with the surface of the metal film; a first light-detecting step in which when another surface of the metal film is irradiated with light at a specified angle of incidence as the surface of the metal film is contacted by the liquid sample that is not labeled with the fluorescent material so as to generate an enhanced field, the light being generated in neighborhood of the surface of the metal film is detected; a mixing step in which the liquid sample is mixed with a second specifically binding material that is labeled with the fluorescent material and which specifically binds to the analyte to bind the analyte and the second specifically binding material so that the analyte is labeled with the fluorescent material; a second liquid sample feeding step in which the liquid sample mixed in the mixing step that contains the analyte as labeled with the fluorescent material is brought into contact with the surface of the metal film; a second light-detecting step in which when another surface of the metal film is irradiated with light at the specified angle of incidence as the surface of the metal film is contacted by the liquid sample that contains the analyte as labeled with the fluorescent material so as to generate an enhanced field, the light being generated in neighborhood of the surface of the metal film is detected; and a substance detecting step in which the analyte in the liquid sample is detected based on a first value detected in the first light-detecting step and a second value detected in the second light-detecting step.

### BRIEF DESCRIPTION OF THE DRAWINGS

FIG. 1 is a block diagram showing a general construction of an embodiment of a sensing apparatus that uses the probe chip of the present invention;

FIG. 2A is a top view showing a general layout of a light source, an optical unit for incident light, and the probe chip in the sensing apparatus shown in FIG. 1;

FIG. 2B is a section of FIG. 2A taken along line B-B;

FIG. 3 is an enlarged schematic view showing enlarged a part of the metal film on the probe chip shown in FIGS. 2A and 2B;

FIGS. 4A to 4D are illustrations showing how a liquid sample flows in the probe chip;

FIG. 5 is an enlarged schematic view showing enlarged a part of the metal film with the liquid sample having reached it;

FIG. 6A is a top view showing another example of the probe chip of the present invention;

FIG. 6B is a section of FIG. 6A taken along line B-B;

FIGS. 7A to 7D are illustrations showing how a liquid sample flows in the probe chip shown in FIG. 6A;

FIG. 8 is a top view showing yet another example of the probe chip of the present invention;

FIG. 9 is a top view showing still another example of the probe chip of the present invention;

FIG. 10 is a block diagram showing a general construction of another embodiment of the sensing apparatus of the present invention;

FIG. 11A is a top view showing a general layout of the probe chip as used in the sensing apparatus shown in FIG. 10;

FIG. 11B is a section of FIG. 11A taken along line B-B;

FIG. 11C is a section of FIG. 11A taken along line C-C; and

FIGS. 12A to 12G are illustrations that depict the method of detecting substances with the sensing apparatus shown in FIG. 10.

### DESCRIPTION OF THE PREFERRED EMBODIMENTS

The probe chip of the present invention, as well as the sensing apparatus that uses the chip and the method of detecting substances using the chip are described on the following pages by referring to the embodiments shown in the accompanying drawings.

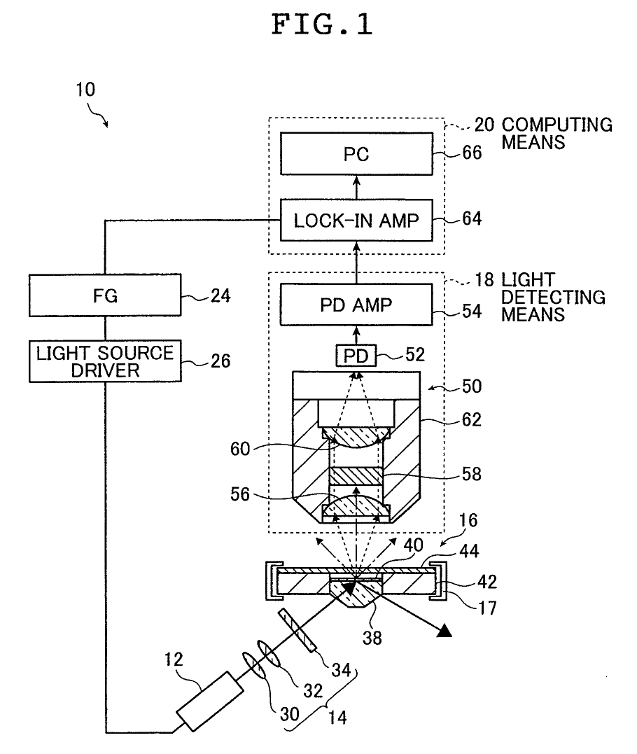

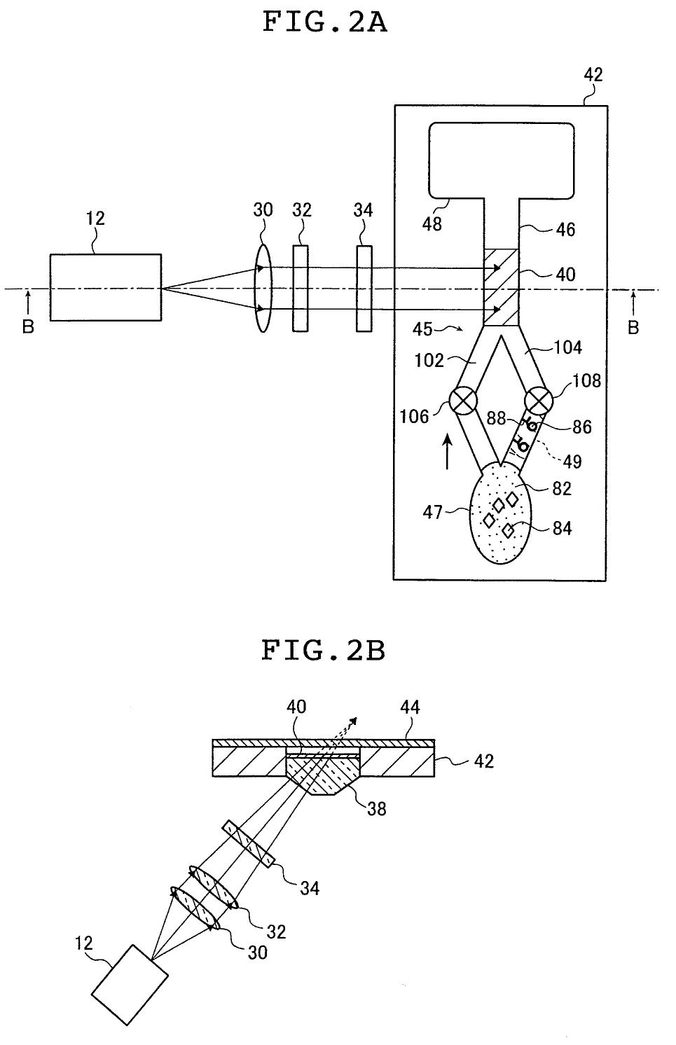

FIG. 1 is a block diagram showing a general construction of an embodiment of the sensing apparatus of the present invention that uses the probe chip of the present invention; FIG. 2A is a top view showing a general layout of a light source 12, an optical unit for incident light 14, and a probe chip 16 in the sensing apparatus 10 shown in FIG. 1; and FIG. 2B is a section of FIG. 2A taken along line B-B.

As shown in FIG. 1 as well as in FIGS. 2A and 2B, the sensing apparatus which is generally indicated by 10 comprises basically a light source 12 that issues light of a specified wavelength, an optical unit for incident light 14 that guides and condenses the light issued from the light source 12 (which is hereinafter sometimes referred to as the exciting light), a probe chip 16 that holds a liquid sample (to be measured) 82 that contains an analyte 84 and which is to be struck with the light condensed by the optical unit for incident light 14, a probe chip support means 17 for supporting the probe chip 16, a light detecting means 18 for detecting the light that is issued from a measurement position on the probe chip 16, and a computing means 20 which, on the basis of the result of detection by the light detecting means 18, detects the analyte 84 (namely, digitizes the signal as detected by the light detecting means 18, checks for the presence of the analyte, and determines its concentration if it is present); having this construction, the sensing apparatus 10 detects (and measures) the analyte 84 contained in the liquid sample 82.

The sensing apparatus 10 further includes a function generator (hereinafter abbreviated as FG) 24 for modulating the exciting light, and a light source driver 26 by means of which an electric current proportional to the voltage generated in the FG 24 is flowed into the light source 12.

The FG 24 is a signal generator that generates repeating clocks at high and low voltages. When the FG 24 causes a signal to flow into the light source driver 26 which then supplies the light source 12 with an electric current proportional to the generated voltage, the light source 12 emits light as modulated in accordance with the clocks. The clocks from the FG 24 are inputted to a lock-in amplifier 64 which in turn picks up only the signal that is synchronous with the clocks from an output of the light detecting means 18.

Although not shown, all parts of the sensing apparatus 10 other than the probe chip 16 are also supported by support mechanisms to fix their relative positions.

The light source 12 is a light issuing device that issues light of a specified wavelength. The light issuing device may be of various types including a semiconductor laser, an LED, a lamp, and an SLD.

The optical unit for incident light 14 comprises a collimator lens 30, a cylindrical lens 32, and a polarizing filter 34, which are inserted into the optical path of the exciting light and arranged in that order, with the collimator lens 30 being the closest to the light source 12. Hence, the light issued from the light source 12 passes through the collimator lens 30, cylindrical lens 32, and polarizing filter 34 in that order and is then launched into the probe chip 16.

The collimator lens 30 is a device by which the light that is issued from the light source 12 to spread radially through a specified angle is converted to parallel light.

As shown in FIGS. 2A and 2B, the cylindrical lens 32 is a columnar lens whose axis extends parallel to the length of the channels in the probe chip which will be described later; by means of this lens, the light that has been rendered parallel by passage through the collimator lens 30 is condensed to focus on only a plane normal to the axis of the column (a plane parallel to the paper on which FIG. 2B is drawn).

The polarizing filter 34 is one by which the light passing through it is P-polarized with respect to the reflecting surface of the probe chip 16 which will be described later.

The probe chip 16 comprises a prism 38, a metal film 40, a substrate 42, and a transparent cover 44; the metal film 40 is formed on one surface of the prism 38 so that a liquid sample 82 containing the analyte 84 is placed on top of the metal film 40.

The prism 38 is generally in the form of a triangular prism with a cross section shaped like an isosceles triangle (to be more exact, the prism is in the form of a hexagonal cylinder as obtained by cutting off the apices of the isosceles triangle in cross section through a plane either normal or parallel to the base of the isosceles triangle); this prism is on the optical path of the light that is issued from the light source 12 to be condensed by the optical unit for incident light 14.

The prism 38 is positioned in such a way that the light condensed by the optical unit for incident light 14 is incident on one of three sides that is defined by one of the two oblique sides of the isosceles triangle.

The prism 38 may be formed of a known transparent resin or optical glass; for example, it may be formed of ZEONEX® 330R (n=1.50; product of ZEON CORPORATION). However, in order to reduce the production cost, it is preferred to form the prism 38 of resins rather than optical glass; exemplary resins that may be used include polymethyl methacrylate (PMMA), polycarbonates (PC), and amorphous polyolefins (APO) containing cycloolefin.

Having this construction, the prism 38 allows the light condensed by the optical unit for incident light 14 to be incident on the surface that is defined by one of the two oblique sides of the isosceles triangle, the incident light being then reflected by the surface that is defined by the base of the isosceles triangle and emerging from the surface that is defined by the other of the two oblique sides of the isosceles triangle.

The metal film 40 is a thin metal film that is formed on part of that surface of the prism 38 which is defined by the base of the isosceles triangle (the part is specifically an area that includes the area that is illuminated with the light incident on the prism 38).

The metal film 40 may be formed of metals including Au, Ag, Cu, Pt, Ni and Al. In order to suppress its reaction with the liquid sample, Au or Pt is preferably used.

The metal film 40 may be formed by a variety of methods; for example, it may be formed on the prism 38 by sputtering, evaporation, plating, or pasting.

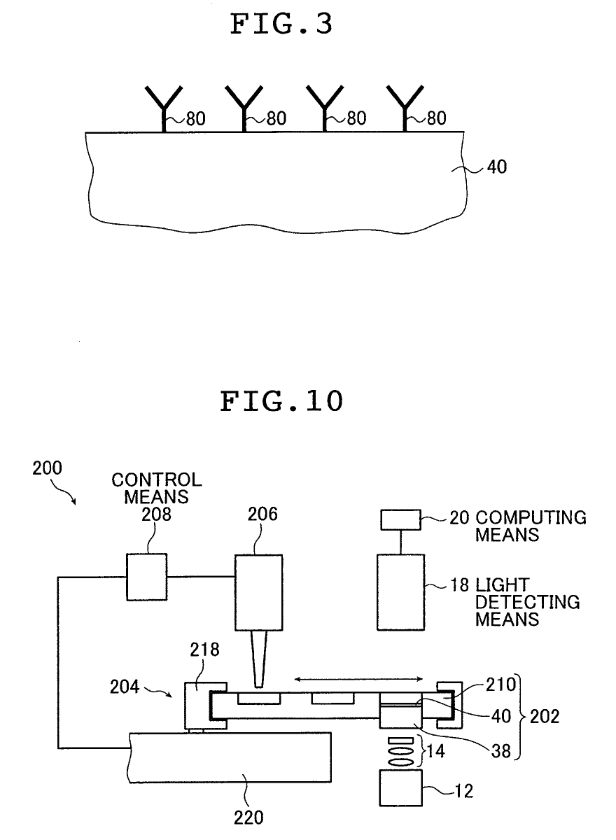

FIG. 3 is an enlarged schematic view showing enlarged a part of the metal film 40 on the probe chip 16 that is shown in FIGS. 2A and 2B.

As shown in FIG. 3, the metal film 40 has a plurality of primary antibodies 80 fixed to its surface as materials that specifically bind to the analyte 84.

The substrate 42 is a member in plate form that is provided on the surface of the prism 38 that is defined by the base of the isosceles triangle and, as shown in FIG. 2A, it has a channel 45 formed in its surface as a passage for feeding the liquid sample 82 across the metal film 40.

The channel 45 consists of a linear portion 46 formed across the metal film 40, a beginning end portion 47 that is formed at one end of the linear portion 46 and serves as a liquid reservoir into which the liquid sample 82 is fed during measurement, and a terminal end portion 48 that is formed at the other end of the linear portion 46 to serve as a liquid reservoir that is reached by the liquid sample 82 that has passed through the linear portion 46 after being fed into the beginning end portion 47.

A zone of the linear portion 46 that lies between the beginning end portion 47 and the metal film 40 consists of two branches as sub-channels, the first branch 102 and the second branch 104.

The second branch 104 has a secondary antibody placement area 49 where secondary antibodies 88 labeled with a fluorescent material 86 (hereinafter referred to simply as “labeled secondary antibodies”) are placed. The secondary antibodies 88 are each a material that specifically binds to the analyte 84.

The probe chip 16 under consideration has the first on-off valve 106 provided within the first branch 102 and the second on-off valve 108 provided within the second branch 104.

The first on-off valve 106 controls the opening and closing of the first branch 102; when the first on-off valve 106 is opened, the liquid sample can be made to pass through the first branch 102, but when it is closed, the liquid sample will no longer flow into the first branch 102.

The second on-off valve 108 controls the opening and closing of the second branch 104; when the second on-off valve 108 is opened, the liquid sample can be made to pass through the second branch 104, but when it is closed, the liquid sample will no longer flow into the second branch 104.

The first on-off valve 106 and the second on-off valve 108 are not particularly limited in terms of structure and a variety of on-off valves may be employed as long as they can control the closing and opening of channels.

The transparent cover 44 is a transparent member in plate form that is joined to that surface of the substrate 42 which is away from the surface in contact with the prism 38. By closing that surface of the substrate 42 which is away from the surface in contact with the prism 38, the transparent cover 44 seals the channel 45 formed in the substrate 42.

The transparent cover 44 has two openings formed in it, one in the area that corresponds to the beginning end portion 47 of the channel 45 and the other in the area that corresponds to its terminal end portion 48. If desired, the opening formed in the position that corresponds to the beginning end portion 47 (as well as the opening formed in the position that corresponds to the terminal end portion 48) may be provided with a lid that can be opened or closed.

Described above is the construction of the probe chip 16. It should be noted here that the prism 38 as well as the metal film 40 and the substrate 42 are preferably formed monolithically.

The probe chip support means 17 is a fixative member that secures the probe chip 16 in a specified position; by the probe chip support means 17, the probe chip 16 is detachably supported in such a way that it assumes specified positions relative to the light source 12, the optical unit for incident light 14, and the light detecting means 18 which will be described later.

The light source 12, the optical unit for incident light 14 and the probe chip 16 are arranged in such relative positions that the light issued from the optical unit 14 to be incident on the prism 38 is totally reflected by the boundary surface between the prism 38 and the metal film 40 to emerge from the other surface of the prism 38.

The light detecting means 18 comprises a detecting optical unit 50, a photodiode (hereinafter PD) 52 and a photodiode amplifier (hereinafter PD amp) 54, and it detects light as it emerges from the neighborhood of the metal film 40 in the probe chip 16 (namely, from the liquid sample 82 on the metal film 40).

The detecting optical unit 50 comprises a first lens 56, a cut-off filter 58, a second lens 60, and a support member 62 that supports these members; it condenses the light emerging from the surface of the metal film 40 (namely, the light emitted on the metal film 40) and allows it to be launched into the PD 52. In the detecting optical unit 50, the first lens 56, the cut-off filter 58 and the second lens 60, as spaced from each other, are arranged in that order on the optical path of the light emitted on the metal film 40, with the first lens 56 being the closest to the metal film 40.

The first lens 56 is a collimator lens provided in a face-to-face relationship with the metal film 40; it renders parallel the light that has reached it after being emitted on the metal film 40.

The cut-off filter 58 has such a characteristic that it selectively cuts off a light component that has the same wavelength as the exciting light but transmits a light component having a different wavelength than the exciting light (e.g., fluorescence originating from the fluorescent material 86); thus, the cut-off filter 58 transmits only that portion of the collimated light from the first lens 56 that has a different wavelength than the exciting light.

The second lens 60 is a condenser lens which condenses the light passing through the cut-off filter 58 and allows it to be launched into the PD 52.

The support member 62 is a holding member that holds the first lens 56, the cut-off filter 58 and the second lens 60 monolithically as they are spaced from each other.

The PD 52 is an optical detector that converts received light to an electric signal; the light that has been condensed by the second lens 60 and launched into the PD 52 is converted to an electric signal. The PD 52 sends the electric signal to the PD amp 54 as a detection signal.

The PD amp 54 is an amplifier that amplifies detection signals, so it amplifies the detection signal coming from the PD 52 and sends the amplified detection signal to the computing means 20.

Comprising a lock-in amp 64 and a PC (e.g., an arithmetic section) 66, the computing means 20 computes the mass of the analyte, its concentration and the like from the detection signal.

The lock-in amp 64 is an amplifier that amplifies that component of the detection signal which has the same frequency as a reference signal, so it amplifies that component of the detection signal as amplified by the PD amp 54 which is synchronous with the reference signal sent from the FG 24. The detection signal amplified by the lock-in amp 64 is run (outputted) into the PC 66.

The detection signal fed into the PC 66 from the lock-in amp 64 is converted to a digital signal, based on which the PC 66 detects the concentration of the analyte in the sample. The concentration of the analyte in the sample can be computed from the relationship between the number of analytes and the liquid volume. The number of analytes can be computed from a calibration curve that is constructed on the basis of the relationship between the intensity of the detection signal and the number of analytes as computed using a known number of analytes. Note that by feeding a constant volume of the liquid sample to the channel 45 in the substrate 42 of the probe chip 16 (or designing the probe chip 16 such that a constant volume of the liquid sample will be fed), the concentration of the analyte can be computed in an easy but correct way.

Described above is the basic construction of the sensing apparatus 10.

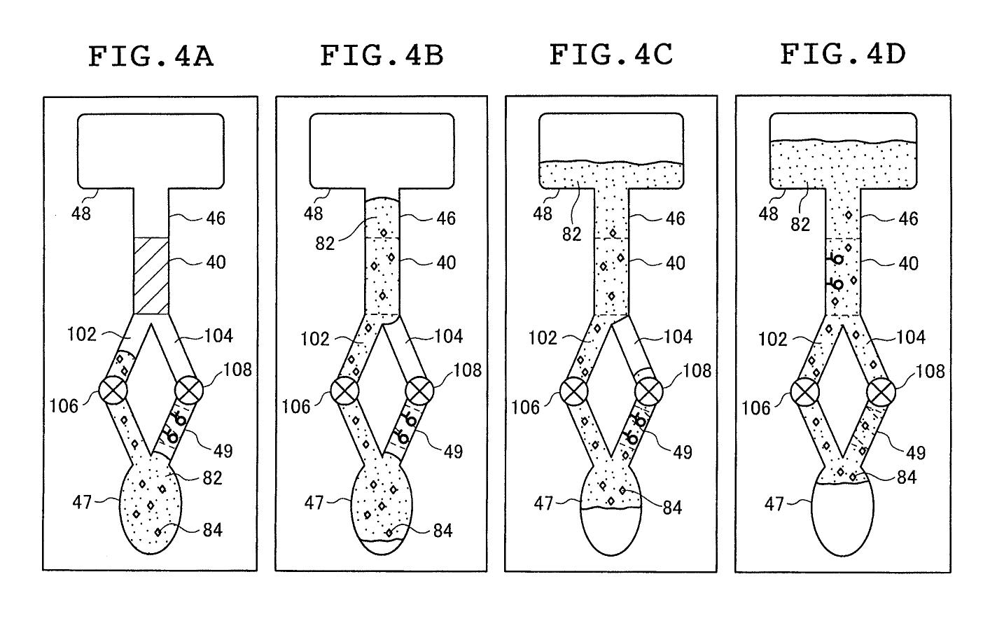

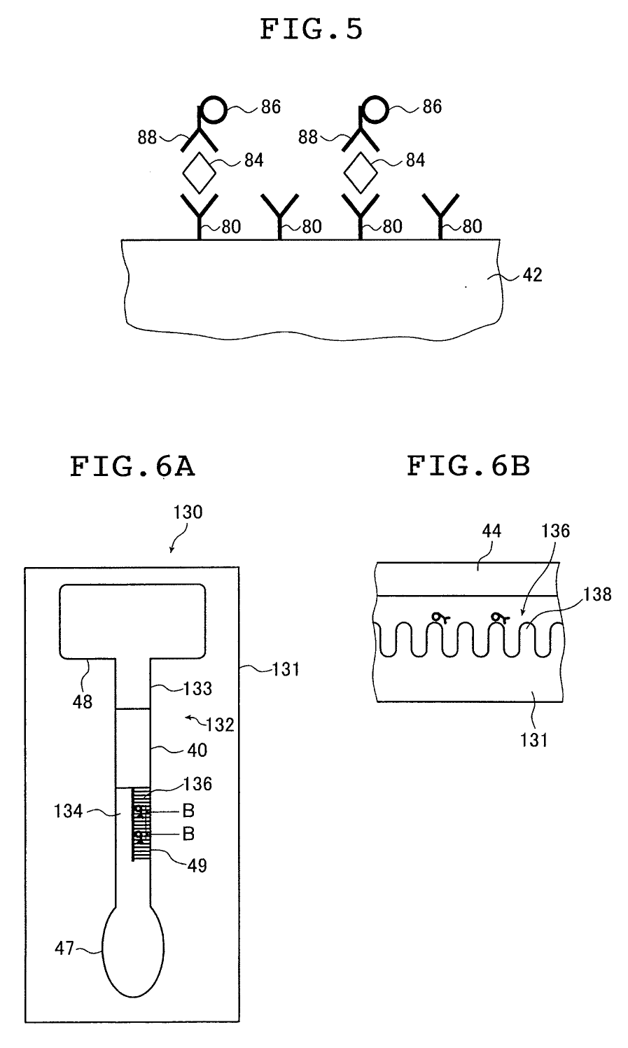

The present invention will be described below in greater detail by describing the method of detecting substances with the sensing apparatus 10 using the probe chip 16. FIGS. 4A to 4D illustrate how the liquid sample 82 flows in the probe chip 16, and FIG. 5 is an enlarged schematic view showing enlarged a part of the metal film 40 as the liquid sample 82 has reached it.

To begin with, the first on-off valve 106 is opened but the second on-off valve 108 is closed to make the liquid sample 82 flowable only into the first branch 102.

In this state, the liquid sample 82 containing the analyte 84 is dripped in (or dispended to) the beginning end portion 47 of the channel 45 in the substrate 42 of the probe chip 16. The liquid sample 82 that has been dripped in the beginning end portion 47 starts to move towards the terminal end portion 48 through the tube defined by the linear portion 46 and the transparent cover 44 since it is shaped like a capillary tube.

As already mentioned, the liquid sample 82 has been made to be flowable only into the first branch 102, so the liquid sample 82 that has moved from the beginning end portion 47 to the linear portion 46 will move through the first branch 102 as shown in FIG. 4A.

As it moves through the first branch 102 towards the terminal end portion 48, the liquid sample 82 will reach the metal film 40 and then continues to move down to the terminal end portion 48 as shown in FIG. 4B.

When the liquid sample 82 passing through the first branch 102 has reached the metal film 40, the sensing apparatus 10 allows the light source 12 to issue the exciting light so as to create an enhanced electric field on the metal film 40 (as will be described later in detail, the electric field has been enhanced by surface plasmons and surface plasmon resonance) and, then, the light issued from the neighborhood of the surface of the metal film 40 is detected by the light detecting means 18 to acquire the detection signal P0.

The detection signal P0 is a signal obtained by the light detecting means 18 that has received the light issued from the surface of the metal film 40 as it is covered with the liquid sample 82 that does not contain any labeled secondary antibodies (in other words, the metal film 40 is in contact with the liquid sample 82) and it is a background signal that is free from the fluorescence from the fluorescent material 86. A specific method of acquiring the detection signal will be described later in detail.

When the detection signal P0 has been acquired, the second on-off valve 108 is opened but the first on-off valve 106 is closed to make the liquid sample 82 flowable only into the second branch 104.

When the first on-off valve 106 is closed and the second on-off valve 108 opened, the liquid sample 82 in the first branch 102 will not move but the liquid sample 82 in the beginning end portion 47 starts to move through the second branch 104 as shown in FIG. 4C.

The liquid sample 82 moving from the beginning end portion 47 through the second branch 104 of the linear portion 46 towards the terminal end portion 48 will reach the secondary antibody placement area 49. When the liquid sample 82 reaches the secondary antibody placement area 49, an antigen-antibody reaction takes place between the analyte 84 contained in the liquid sample 82 and the secondary antibody 88 (namely, the labeled secondary antibody) placed in the secondary antibody placement area 49, whereupon the analyte 84 binds to the secondary antibody 88. Since the secondary antibody 88 has been labeled with the fluorescent material 86, the analyte 84 that has bound to the secondary antibody 88 becomes labeled with the fluorescent material 86.

The liquid sample 82 that has passed through the secondary antibody placement area 49 keeps moving through the second branch 104 towards the terminal end portion 48 until it reaches the metal film 40 in the linear portion 46. When the liquid sample 82 has reached the metal film 40, an antigen-antibody reaction takes place between the analyte 84 contained in the liquid sample 82 and the primary antibody 80 fixed on the metal film 40, whereby the analyte 84 is captured by the primary antibody 80 (see FIG. 5). Since the analyte 84 captured by the primary antibody 80 has already been labeled with the fluorescent material 86 in the secondary antibody placement area 49, the primary antibody 80 that has captured the analyte 84 becomes labeled with the fluorescent material 86. In other words, the analyte 84 becomes sandwiched between the primary antibody 80 and the labeled secondary antibody.

The liquid sample 82 that has passed through the metal film 40 moves down to the terminal end portion 48. In addition, both the analyte 84 that has not been captured by the primary antibody 80 and the labeled secondary antibody that has not bound to the analyte 84 also move down to the terminal end portion 48 together with the liquid sample 82.

As shown in FIG. 4D, this leaves on the metal film 40 the analyte 84 that has bound to the labeled antibody, that is labeled with the fluorescent material 86 and that has been captured by the primary antibody 80.

When the liquid sample 82 that had passed through the second branch 104 to cause the analyte 84 to bind to the labeled secondary antibody has reached the metal film 40, the sensing apparatus 10 causes the exciting light to issue from the light source 12 so as to generate an enhanced electric field on the metal film 40 and, then, the light issued from the neighborhood of the surface of the metal film 40 is detected by the light detecting means 18 to acquire the detection signal P.

The detection signal P is a signal obtained by the light detecting means 18 that has received the light issued from the surface of the metal film 40 where the analyte 84 tagged by the labeled secondary antibody has been captured by the first antibody 80 and it is a signal that contains the fluorescence from the fluorescent material 86.

Let us now describe in detail the methods of acquiring the detection signals P0 and P.

Since the two detection signals are acquired by the same method except for the state of the liquid sample 82 on the metal film 40 (specifically, whether it involves fluorescence from the fluorescent material 86 or not), the case of acquiring the detection signal P is taken as a representative example and described below.

To begin with, when the liquid sample 82 passing through the second branch 104 has reached the metal film 40, creating a state in which the detection signal P can be acquired, the light source 12 is caused to issue the exciting light based on the current flowing from the light source driver 26 in response to the intensity modulated signal as determined in the FG 24.

The exciting light issued from the light source 12 passes through the optical unit for incident light 14. Specifically, the exciting light is rendered parallel by the collimator lens 30, then condensed by the cylindrical lens 32 in only one direction, and is thereafter polarized by the polarizing filter 34.

The light passing through the optical unit 14 is incident on the prism 38, through which it travels as a beam having a specified angular range until it reaches the boundary surface between the prism 38 and the metal film 40; the light is then reflected totally by the boundary surface between the prism 38 and the metal film 40 to emerge from the prism 38. Note that the cylindrical lens 32 condenses the light in such a way that it is focused at a position a certain distance beyond the boundary surface between the prism 38 and the metal film 40.

As mentioned above, the parallel light generated by the collimator lens 30 is condensed by the cylindrical lens 32 in only one direction and this ensures that the exciting light has the same angle of incidence in a direction parallel to the direction in which the linear portion 46 extends across the boundary surface between the prism 38 and the metal film 40.

As the result of the total reflection of the exciting light that occurs at the boundary surface between the prism 38 and the metal film 40, an evanescent wave penetrates the metal film 40 to appear on the surface where the channel 45 is formed (opposite the surface in contact with the prism 38) and this evanescent wave excites surface plasmons in the metal film 40. The excited surface plasmons produce an electric field distribution on the surface of the metal film 40 to form an area having an enhanced electric field.

On this occasion, the evanescent wave and surface plasmons that have been generated by that portion of the exciting light incident at angles in a specified range which struck the boundary surface between the prism 38 and the metal film 40 at a specified angle (specifically, at the angle that satisfies the plasmon resonance condition) resonates with each other, causing surface plasmon resonance (the plasmon enhancement effect). In the area where this surface plasmon resonance (plasma enhancing effect) has been caused, a more intense enhancement of the electric field is realized. The plasmon resonance condition as referred to above is such a condition that the wavenumber of the evanescent wave generated by the incident light becomes equal to the wavenumber of surface plasmons to establish a wavenumber match. As already mentioned, this plasmon resonance condition depends on various factors including the type of the sample, its state, the thickness of the metal film, its density, the wavelength of the exciting light, and its incident angle. Also note that in the invention the plasmon resonance angle and the incident angle of the exciting light (each of its rays) are the angle it forms with the line normal to the metal film.

It should also be noted that if the fluorescent material 86 is present in the area where the evanescent wave has come out, it is excited to generate fluorescence. This fluorescence is enhanced by the effect for field enhancement of the surface plasmons that are present in an area substantially comparable to the area where the evanescent wave has come out, particularly by the effect for field enhancement that has been enhanced by the surface plasmon resonance.

Note that the fluorescent material that is outside the area where the evanescent wave has come out is not excited and hence does not generate fluorescence.

In this way, the fluorescence from the fluorescent material 86 with which the analytes 84 fixed on the metal film 40 are labeled is excited and enhanced.

The light issuing from the fluorescent material 86 after being excited by the surface plasmons is incident on the first lens 56 in the light detecting means 18, passes through the cut-off filter 58, is condensed by the second lens 60, and is launched into the PD 52 where it is converted to an electric signal. Since that component of the light that is incident on the first lens 56 and which has the same wavelength as the exciting light cannot pass through the cut-off filter 58, the exciting light component does not reach as far as the PD 52.

The electric signal generated in the PD 52 is amplified as the detection signal P in the PD 54 and thence fed into the lock-in amp 64, where it amplifies the signal component that is synchronous with the reference signal. As a result, the light generated on account of the exciting light can be sufficiently amplified for any unwanted noise components (for example, the light that has been launched into the PD 52 other than from the detecting optical unit 50, as exemplified by the light from fluorescent lamps in a room or the light from sensors in the apparatus, as well as the dark current generated in the PD 52) to be positively distinguished from the light issuing from the fluorescent material 86.

The detection signal P as amplified by the lock-in amp 64 is sent to the PC 66.

This is the way the detection signal P is acquired. As already mentioned, the detection signal P0 is acquired by essentially the same method.

Using the thus acquired detection signals P0 and P, the PC 66 performs baseline subtraction (specifically, computes a difference Δ=P−P0) and computes the signal that is due to the fluorescent material but from which the background has been removed.

The PC 66 performs A/D conversion on the signal, and based on a preliminarily stored calibration curve, it detects the concentration of the analyte 84 in the liquid sample 82 from the result of computation about the analyte 84.

In the manner described above, the sensing apparatus 10 detects the mass and concentration of the analytes 84 in the liquid sample 82.

In the sensing apparatus 10, valve switching is effected to determine which branch should be used to pass the liquid sample 82 which has been dripped in the beginning end portion 47, and to acquire the detection signal P0 for the light that is issued from the surface of the metal film 40 as it is covered with the liquid sample 82 in which the analytes 84 are not labeled with the labeled secondary antibodies and the detection signal P for the light that is issued from the surface of the metal film 40 as it is covered with the liquid sample 82 in which the analytes 84 are labeled with the labeled secondary antibodies, and baseline subtraction is performed using the two detection signals P0 and P; as a result, noise can be appropriately removed and the fluorescence due to the fluorescent material 86 with which the analytes 84 are labeled can be detected more accurately.

In concrete terms, the sensing apparatus 10 detects the background signal with the metal film 40 being covered with the liquid sample 82 and this ensures that the surface of the metal film 40 has the same refractive index as is obtained by the actual measurement; as a result, the plasmon resonance condition that is established in the case of acquiring the detection signal P0 is substantially the same as that in the case of acquiring the detection signal P and, hence, the background can be measured advantageously enough to achieve accurate noise removal.

As a further advantage, there is no need to provide a mechanism for changing the incident angle of the exciting light in accordance with variations in the plasmon resonance angle, and this contributes to preventing the apparatus from becoming complex in configuration, bulky in size, and expensive.

Furthermore, acquiring the detection signal P0 from the liquid sample as it is placed in contact with the metal film enables more accurate noise detection than in the case of using a buffer solution. Since there is no need to provide a fresh liquid, the apparatus can be simplified in configuration and made less expensive.

As an additional advantage, the two detection signals P0 and P can be positively acquired by only performing a switch between two on-off valves on a single probe chip, which contributes to a simpler assay.

What is more, the background can be easily measured and noise removed for each probe; as a result, even the noise that changes with different probe chips can be accurately detected and the permissible errors in the probe chip can be made great enough to enable the manufacture of probe chips at lower cost.

It should be noted here that the probe chip 16 is preferably provided with a suction means that aspirates any liquid sample that stays in the terminal end portion 48 provided at the terminal end of the channel 45. By aspirating the liquid sample in the terminal end portion 48 by the suction means, the flow of the liquid sample can be promoted to perform detection (and measurement) in a shorter period of time.

In the foregoing embodiment of the probe chip 16, the opening and closing of the first branch 102 are controlled by the first on-off valve 106 and those of the second branch 104 are controlled by the second on-off valve 108; however, this is not the sole case of the present invention and any structural design is possible as long as it is capable of controlling the opening and closing of the first branch 102 and the second branch 104; for example, a switching means may be provided in the position where the first branch 102 and the second branch 104 diverge, in such a way that the state where the channel extending from the beginning end portion 47 is connected to the first branch 102 is changed to the state where the channel extending from the beginning end portion 47 is connected to the second branch 104, and vice versa.

In the probe chip 16 described in the foregoing embodiment, the first on-off valve 106 and the second on-off valve 108 are provided in such a design that they can be operated to select which of the two branches, the first branch 102 or the second branch 104, is used as the passage of the liquid fluid, and after the liquid sample passing through the first branch 102 is allowed to reach the metal film 40 and measurement is performed, the liquid sample passing through the second branch 104 is allowed to reach the metal film 40 and measurement is performed; however, this is not the sole case of the present invention and an alternative design may be adopted: the time it takes for the liquid sample passing through the first branch to reach the metal film is made to differ from the time it takes for the liquid sample passing through the second branch to reach the metal film; specifically, the liquid sample passing through the first branch is first allowed to reach the metal film and after the lapse of a specified time, the liquid sample passing through the second branch is allowed to reach the metal film.

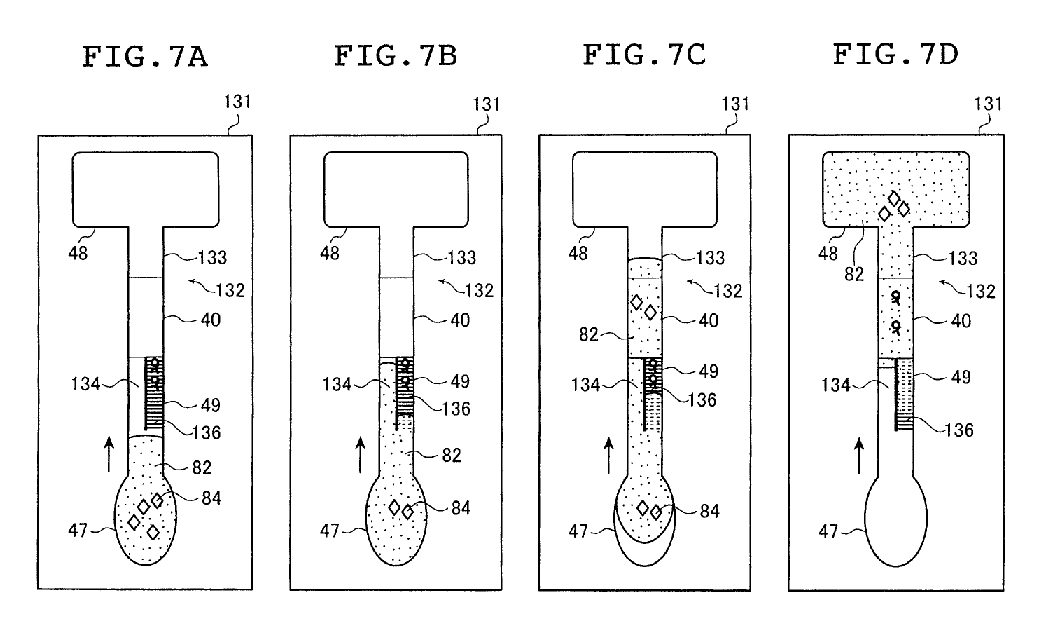

On the following pages, another example of the probe chip of the present invention is described with reference to FIGS. 6A and 6B, as well as FIGS. 7A to 7D.

FIG. 6A is a top-view showing a general structure of a probe chip 130 which is another example of the probe chip of the present invention; FIG. 6B is a section of FIG. 6A taken along line B-B; and FIGS. 7A to 7D are illustrations showing how the liquid sample flows in the probe chip 130 shown in FIGS. 6A and 6B.

Since the probe chip 130 is identical to the probe chip 16 in all aspects of its design except the shape of a linear portion 133 of a channel 132 in a substrate 131, like members and structural aspects are identified by like numerals and will not be described in detail. Also note that in FIG. 6A, the cover is removed to reveal the shape of the channel substrate.

The substrate 131 of the probe chip 130 is a member in plate form that is provided on the surface of the prism 38 that is defined by the base of the isosceles triangle in cross section and it has the channel 132 formed in its surface as a passage for feeding the liquid sample 82 to the metal film 40.

The channel 132 consists of the linear portion 133 formed across the metal film 40, the beginning end portion 47 that is formed at one end of the linear portion 133, and the terminal end portion 48 that is formed at the other end of the linear portion 133.

A zone of the linear portion 133 that lies between the beginning end portion 47 and the metal film 40 consists of two branches as sub-channels, the first branch 134 and the second branch 136. The two branches 134 and 136 are adjacent side by side to form a linear shape, with a liquid-repelling oil-based ink coat being applied to the boundary area between the first branch 134 and the second branch 136.

The first branch 134 is a sub-channel with flat inner wall surfaces.

As shown in FIG. 6B, the second branch 136 has irregularities 138 formed on the bottom surface (the surface that is the closer to the prism 38). To be more specific, a multiple of grooves are formed in the bottom surface in a direction that-crosses the flow direction of the liquid sample at right angles to thereby form the irregularities.

Because of the irregularities 138 formed on the bottom surface of the second branch 136, it takes a longer time for the liquid sample to flow from the beginning end portion 47 to the metal film 40 than the first branch 134 having a flat bottom surface.

Note that the second branch 136 as well as the second branch 104 has the secondary antibody placement area 49 where labeled secondary antibodies are placed.

Since the liquid-repelling oil-based ink coat is applied to the boundary area between the first branch 134 and the second branch 136, the liquid sample flowing through the first branch 134 is suppressed from moving into the second branch 136 and the liquid sample flowing through the second branch 136 is also suppressed from moving into the first branch 134. In the embodiment under consideration, the liquid-repelling oil-based ink coat is applied but this is not the sole case of the present invention and the same effect is obtained by providing a liquid-repelling member at the boundary area between the first branch 134 and the second branch 136. For example, a partition formed of a liquid-repelling material may be provided.

On the following pages, the flow of the liquid sample 82 in the probe chip 130 is described.

To begin with, the liquid sample 82 containing the analyte is dripped in the beginning end portion 47 of the probe chip 130. The liquid 82 that has been dripped in the beginning end portion 47 starts to move towards the terminal end portion 48 through the tube defined by the linear portion 133 and the transparent cover 44 since it is shaped like a capillary tube.

The liquid sample 82 flowing from the beginning end portion 47 towards the terminal end portion 48 flows through the linear portion 133 and reaches the first branch 134 and the second branch 136, as shown in FIG. 7A.

Having reached the first branch 134 and the second branch 136, the liquid sample 82 continues to move towards the terminal end portion 48. Since the irregularities 138 are formed in the second branch 136, the liquid sample 82 moving through the first branch 134 is faster than the liquid sample 82 moving through the second branch 136. Thus, the liquid sample 82 moving through the first branch 134 approaches the terminal end portion 48 earlier than the liquid sample 82 moving through the second branch 136, as shown in FIG. 7B.

The liquid samples 82 moving through the first branch 134 and the second branch 136 make a further movement towards the terminal end portion 48 and, then, the liquid sample 82 moving through the first branch 134 arrives at the metal film 40 before the liquid sample 82 moving through the second branch 136, as shown in FIG. 7C.

When the liquid sample 82 passing through the first branch 134 (namely, the liquid sample 82 in which the analyte 84 is not labeled with the fluorescent material 86) has reached the metal film 40 as shown in FIG. 7C, the sensing apparatus 10 issues the exciting light from the light source 12 to generate an enhanced electric field on the metal film 40 and, then, the light emitted from the neighborhood of the metal film 40 is detected by the light detecting means 18 to acquire the detection signal P0.

Thereafter, the liquid samples 82 moving through the first branch 134 and the second branch 136 make a further movement towards the terminal end portion 48 until the liquid sample 82 moving through the second branch 136 also arrives at the metal film 40, as shown in FIG. 7D.

When the liquid sample 82 passing through the second branch 136 (namely, the liquid sample 82 in which the analyte 84 is labeled with the fluorescent material 86) has reached the metal film 40 as shown in FIG. 7D, the sensing apparatus 10 issues the exciting light from the light source 12 to generate an enhanced electric field on the metal film 40 and, then, the light emitted from the neighborhood of the metal film 40 (containing the fluorescence from the fluorescent material, as enhanced by the enhanced electric field) is detected by the light detecting means 18 to acquire the detection signal P.

As described above, the probe chip 130 has the irregularities 138 formed in the second branch 136 and the liquid sample moving through the second branch 136 flows less fast than the liquid sample moving through the first branch 134; as a result, the detection signal P0 for the state where the metal film 40 is covered with the liquid sample 82 in which the analyte 84 is not labeled with the fluorescent material 86 is first acquired and then acquired is the detection signal P for the state where the metal film 40 is covered with the liquid sample 82 in which the analyte 84 is labeled with the fluorescent material 86.

Thus, the probe chip 130 can also detect the background signal while removing the noise in an appropriate manner at the same plasmon resonance angle as in the measurement for detecting the fluorescence from the fluorescent material, and the analyte can be detected with high precision to achieve the same advantage as the probe chip 16 according to the first embodiment of the present invention. A sensing apparatus using this probe chip 130 can achieve the same advantage as the above-described sensing apparatus 10.

In the second embodiment described above, the second branch 136 has the irregularities 138 formed in it, thereby causing the liquid sample to flow less fast than in the first branch 134; however, this is not the sole example of the shape of the second branch in the probe chip and the sensing apparatus of the present invention and it may have any shape that causes the liquid sample to reach the detection surface at a later time than in the first branch.

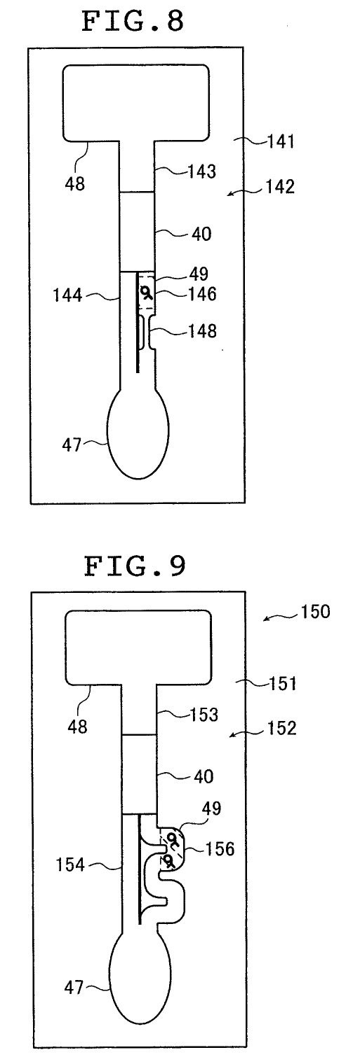

FIGS. 8 and 9 are top views showing other embodiments of the probe chip. The embodiments shown in FIGS. 8 and 9 have basically the same structure as the probe chip 130 shown in FIG. 6A, except for the shape of the second branch, so like members and structural features are identified by like numerals and will not be described in detail. Also note that in FIGS. 8 and 9, the cover is removed to reveal the shape of the channel substrate.

The probe chip 140 shown in FIG. 8 has a channel 142 formed in a substrate 141 and a linear portion 143 of this channel consists of a first branch 144 and a second branch 146. The second branch 146 has a constricted area 148 that is less wide than the other areas. Because of the existence of this constricted area 148, the liquid sample moving through the second branch 146 is less fast than the liquid sample moving through the first branch 144. As a result, it is after the liquid sample 82 moving through the first branch 144 has reached the metal film 40 that the liquid sample 82 moving through the second branch 146 reaches the same metal film. Consequently, as in the foregoing embodiments, baseline subtraction can be performed and noise removal effected appropriately so as to enable precise measurement.

The probe chip 150 shown in FIG. 9 has a channel 152 formed in a substrate 151 and a linear portion 153 of this channel includes a first branch 154 and a second branch 156. The second branch 156 has a greater channel length than the first branch 154. Specifically, as shown in FIG. 9, the first branch 154 has a linear shape whereas the second branch 156 is serpentine and yet the start points of the two branches are in the same position and so are the end points; hence, the second branch 156 has a greater channel length than the first branch 154 by the amount of the bends it has.

Because of this feature, the liquid sample 82 moving through the second branch 156 has to travel a longer distance than the liquid sample moving through the first branch 154, and it is after the liquid sample 82 moving through the first branch 154 has reached the metal film 40 that the liquid sample 82 moving through the second branch 156 reaches the same metal film. Consequently, as in the foregoing embodiments, baseline subtraction can be performed and noise removal effected appropriately so as to enable precise measurement.

In the next place, another embodiment of the sensing apparatus of the present invention is described.

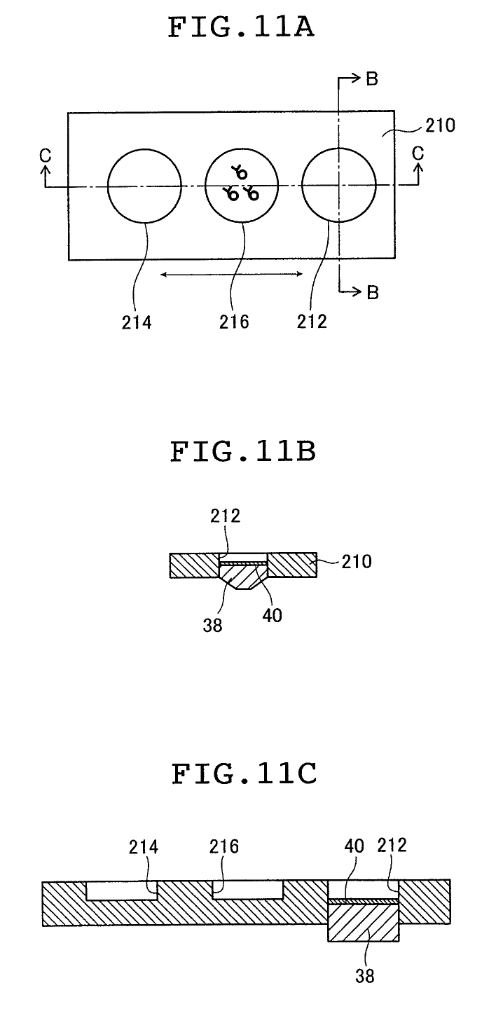

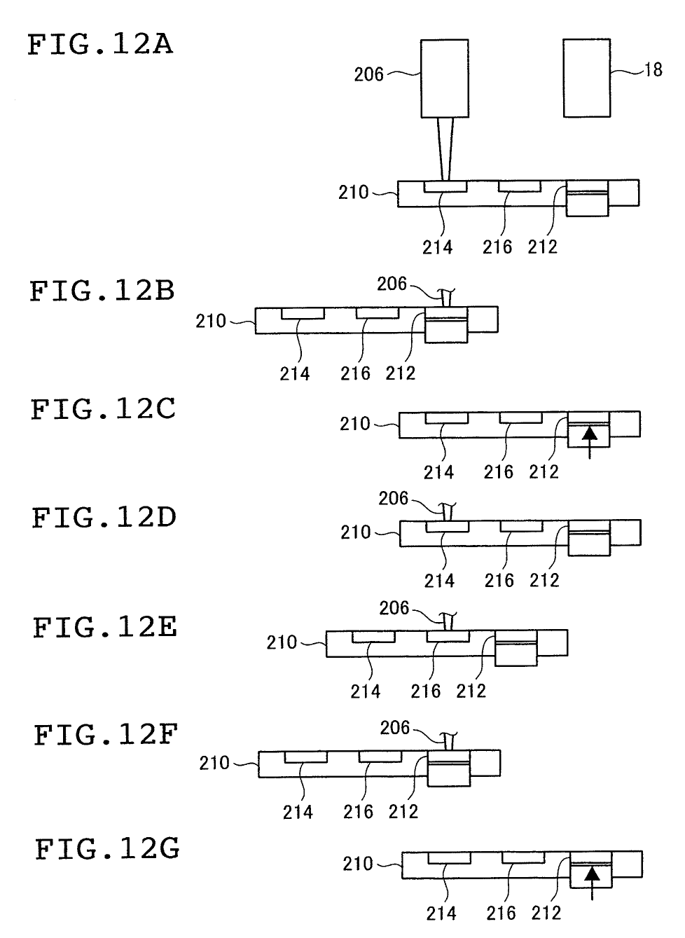

FIG. 10 is a block diagram showing a general construction of a sensing apparatus 200 which is another embodiment of the sensing apparatus of the present invention. FIG. 11A is a top view showing a general layout of a probe chip 202 as used in the sensing apparatus 200 shown in FIG. 10; FIG. 11B is a section of FIG. 11A taken along line B-B; and FIG. 11C is a section of FIG. 11A taken along line C-C. In addition, FIGS. 12A to 12G are illustrations for the method of detecting substances using the sensing apparatus 200 shown in FIG. 10.

As shown in FIG. 10, the sensing apparatus 200 comprises basically the light source 12, the optical unit for incident light 14, a probe chip 202, a probe chip moving means 204, the light detecting means 18, the computing means 20, a dispensing means 206, and a control means 208. Although not shown in FIG. 10, the sensing apparatus 200 as well as the sensing apparatus 10 further includes a FG, a light source driver, and support mechanisms that support various parts of it. The light source 12, optical unit for incident light 14, light detecting means 18, computing means 20, FG, and light source driver have the same structures and functions as the corresponding parts in the sensing apparatus 10 and will not be described in detail.

The probe chip 202 comprises the prism 38, the metal film 40, and a substrate 210; the metal film 40 is formed on one surface of the prism 38 so that the liquid sample 82 containing the analyte 84 is placed on top of the metal film 40.

The prism 38 as well as the counterpart in the probe chip 16 is generally in the form of a triangular prism with a cross section shaped like an isosceles triangle (to be more exact, the prism is in the form of a hexagonal cylinder as obtained by cutting off the apices of the isosceles triangle through a plane either normal or parallel to the base of the isosceles triangle); this prism is on the optical path of the light that is issued from the light source 12 and which is condensed by the optical unit for incident light 14.

The metal film 40 as well as the counterpart in the probe chip 16 is a thin metal film that is formed on part of that surface of the prism 38 which is defined by the base of the isosceles triangle (the part is specifically an area that includes the area that is illuminated with the light incident on the prism 38).

As shown in FIGS. 11A to 11C, the substrate 210 is a member in plate form which has one opening that serves as an opening for measurement 212 and two recesses that serve as a first receptacle 214 and a second receptacle 216. Note that the opening for measurement 212, the first receptacle 214 and the second receptacle 216 are formed in the order of 212, 216 and 214 on a straight line, with the opening for measurement 212 being the closest to one end of the substrate 210.

As shown in FIGS. 11B and 11C, the opening for measurement 212 in the substrate 210 is fitted with the prism 38 that is pressed from the surface where the light source 12 is provided in such a way that the metal film 40 serves as the bottom of the hole that is defined by that opening. In other words, the opening for measurement 212, the metal film 40 and the prism 38 combine to form a recess the lateral side of which is defined by the opening for measurement 212 and the bottom of which is defined by the metal film 40. Thus, the opening for measurement 212 in the substrate 210 serves as a sample holder that holds the liquid sample to prevent it from spilling over the metal film 40 after it has been dripped on the metal film.

The first receptacle 214 is a recess that stores a specified amount of the liquid sample as it is supplied from a liquid sample feed mechanism (not shown). Note that the liquid sample to be stored in the first receptacle 214 is one in which the analytes it contains are not labeled with the fluorescent material.

The second receptacle 216 is a recess in which the labeled secondary antibodies are placed.

The probe chip moving means 204 comprises a probe chip support means 218 that detachably supports the probe chip 202 and a drive mechanism 220 that moves the probe chip support means 218; the drive mechanism 220 moves the probe chip support means 218, which in turn causes the probe chip 202 to move.

Note that the drive mechanism 220 may be of various types including a linear mechanism and a gear mechanism.

Depending on the need, the probe chip moving means 204 causes the probe chip 202 to move to one of the following positions: the position where the light issued from the light source 12 which has passed through the optical unit 14 for incident light is incident on the boundary surface between the metal film 40 that defines the bottom of the opening for measurement 212 in the probe chip 202 and the prism 38; the position where the opening for measurement 212 is in a face-to-face relationship with the dispensing means 206 to be described later; the position where the first receptacle 214 is in a face-to-face relationship with the dispensing means 206; and the position where the second receptacle 216 is in a face-to-face relationship with the dispensing means 206.

Since the opening for measurement 212, the first receptacle 214 and the second receptacle 216 are aligned on a straight line in the embodiment under consideration, it should be noted that the probe chip moving means 204 causes the probe chip 202 to move in a direction parallel to the straight line connecting the opening for measurement 212, the first receptacle 214, and the second receptacle 216 (i.e., in the direction indicated by the two-headed arrow in FIG. 10).

The dispensing means 206 is typically a pipette that aspirates and ejects liquids and it is provided on the path over which the probe chip 202 is moved so that the dispensing means 206 is positioned in a face-to-face relationship with the opening for measurement 212, the first receptacle 214, or the second receptacle 216. In the embodiment under consideration, the dispensing means 206 is spaced a specified distance from the light detecting means 18 in a direction parallel to the direction of movement of the probe chip 202.

The dispensing means 206 aspirates the liquid stored in the opening for measurement 212, the first receptacle 214, or the second receptacle 216 that is in a face-to-face relationship with it or it ejects the aspirated liquid into the associated areas.

The control means 208 controls the timing at which the probe chip 202 is moved by the probe chip moving means 204 and the position to which it is moved, as well as the actions of the dispensing means 206 for aspirating and ejecting the liquid.

The control means 208 is also connected to the light source driver and the light detecting means 18 so as to control the timing at which light is issued from the light source 12, and the timing at which light is detected by the light detecting means 18, as well as synchronizing with the actions of individual parts.

Described above is the basic construction of the sensing apparatus 200.

On the following pages, the method of detecting substances by the sensing apparatus 200 is described to explain the present invention in greater detail. FIGS. 12A to 12G are illustrations for the method of detecting substances with the sensing apparatus 200.

To begin with, the probe chip 202 is moved by the probe chip moving means 204 to the position where the first receptacle 214 is in a face-to-face relationship with the dispensing means 206, as shown in FIG. 12A. Thereafter, the liquid sample stored in the first receptacle 214 is aspirated in a specified amount by the dispensing means 206.

When the dispensing means 206 has aspirated a specified amount of the liquid sample, the probe chip 202 is moved by the probe chip moving means 204 to the position where the opening for measurement 212 is in a face-to-face relationship with the dispensing means 206, as shown in FIG. 12B. Thereafter, the liquid sample aspirated from the first receptacle 214 is ejected by the dispensing means 206 to cover the metal film 40 in the opening for measurement 212.

When the liquid sample has been ejected to cover the metal film 40, the probe chip 202 is moved by the probe chip moving means 204 to the position where the opening for measurement 212 is in a face-to-face relationship with the light detecting means 18 (i.e., the position in which the exciting light is incident on the boundary surface between the prism 38 and the metal film 40), as shown in FIG. 12C. Thereafter, the exciting light is issued from the light source 12 to generate an enhanced electric field on the metal film 40 and then the light issued from the surface of the metal film 40 that is covered with the liquid sample 82 free from the labeled secondary antibodies is detected by the light detecting means 18 to acquire the detection signal P0.

When the detection signal P0 is acquired, the probe chip 202 is moved by the probe chip moving means 204 to the position where the first receptacle 214 is in a face-to-face relationship with the dispensing means 206, as shown in FIG. 12D. Thereafter, the liquid sample stored in the first receptacle 214 is aspirated in a specified amount by the dispensing means 206.

When the dispensing means 206 has aspirated a specified amount of the liquid sample, the probe chip 202 is moved by the probe chip moving means 204 to the position where the second receptacle 216 is in a face-to-face relationship with the dispensing means 206, as shown in FIG. 12E. Thereafter, the liquid sample aspirated from the first receptacle 214 is ejected into the second receptacle 216 by the dispensing means 206. Subsequently, the process of aspirating the liquid sample from the second receptacle 216 and ejecting the aspirated liquid sample into the second receptacle 216 is repeated to agitate the liquid sample in the second receptacle 216. When the agitation of the liquid sample ends, the dispensing means 206 aspirates the liquid sample from the second receptacle 216.

Note here that the second receptacle 216 has the labeled secondary antibodies placed in it. Therefore, by agitating the liquid sample within the second receptacle 216, the analytes and the labeled secondary antibodies in the liquid sample are allowed to bind to each other, creating a state in which the analytes are labeled with the fluorescent material with which the secondary antibodies have been labeled.

When the liquid sample in the second receptacle 216 has been aspirated by the dispensing means 206, the probe chip 202 is moved by the probe chip moving means 204 to the position where the opening for measurement 212 is in a face-to-face relationship with the dispensing means 206, as shown in FIG. 12F. Thereafter, the liquid sample aspirated from the second receptacle 216 is ejected by the dispensing means 206 to cover the metal film 40 in the opening for measurement 212. Since the primary antibodies are fixed on the metal film 40, the analytes in the liquid sample that are labeled with the fluorescent material bind to the primary antibodies and are fixed on the metal film.

When the liquid sample has been ejected to cover the metal film 40, the probe chip 202 is moved by the probe chip moving means 204 to the position where the opening for measurement 212 is in a face-to-face relationship with the light detecting means 18 (i.e., the position in which the exciting light is incident on the boundary surface between the prism 38 and the metal film 40), as shown in FIG. 12G. Thereafter, the exciting light is issued from the light source 12 to generate an enhanced electric field on the metal film 40 and then the light issued from the surface of the metal film 40 that is covered with the liquid sample 82 that contains the labeled secondary antibodies and in which the analytes are labeled with the fluorescent material is detected by the light detecting means 18 to acquire the detection signal P.

Using the thus acquired detection signals P0 and P, the sensing apparatus 200 as well as the above-described sensing apparatus 10 performs baseline subtraction (specifically, computation of a difference Δ=P−P0) to thereby compute the signal that is due to the fluorescent material but from which the background has been removed.

As described above in connection with the sensing apparatus 200, the liquid sample 82 free from the labeled secondary antibodies is dripped on the metal film by the dispensing means to acquire one detection signal and then the liquid sample 82 containing the labeled secondary antibodies is dripped to acquire another detection signal; even in this case, unwanted noise can be removed in an advantageous way to realize precise detection of the analytes.

The method of detecting substances by the above-described sensing apparatus 200 may be modified in such a way that in the process of acquiring the detection signal P, part of the liquid sample held in the opening for measurement is removed in order to eliminate any labeled secondary antibodies that have not bound to the primary antibodies. Alternatively, a liquid waste receptacle may be provided in the substrate of the probe chip to serve as a space into which any labeled secondary antibodies that have not bound to the primary antibodies can be ejected.

Because of the possibility to detect the background signal without involving any labeled secondary antibodies, it is preferred to mix (by agitation) the liquid sample with the labeled secondary antibodies after acquiring the background signal as in the embodiment just described above; however, this is not the sole case of the present invention and the detection signal may be acquired by first mixing the liquid sample with the labeled secondary antibodies through agitation in the second receptacle and thereafter ejecting the liquid sample into the opening for measurement so as to avoid the involvement of the labeled secondary antibodies from the first receptacle.

The present invention is not limited, either, to the method of detecting substances using the above-described sensing apparatus 10 or 200; as long as a detection signal is acquired with the metal film being covered with the liquid sample 82 that is free from the labeled secondary antibodies and another detection signal is then acquired with the metal film being covered with the liquid sample 82 containing the labeled secondary antibodies, the method of dripping those liquid samples, the structure of the probe chip, and other conditions are not limited in any particular way.

While the probe chip according to the present invention as well as the sensing apparatus and the substance detecting method that use the probe chip have been described above in detail, the present invention is by no means limited to the foregoing embodiments and it should be understood that various improvements and modifications are possible without departing from the scope and spirit of the present invention.

In each of the foregoing embodiments, the optical unit for incident light comprises a collimator lens and a cylindrical lens as a condenser lens, and the light issued from the light source is made parallel by passage through the collimator lens and then condensed by the cylindrical lens; this is not the sole case of the present invention and only a condenser lens may be provided so that the light issued from the light source is not made parallel but is simply condensed by the condenser lens.

In the sensing apparatus 10, the optical unit for incident light uses a cylindrical lens or a condenser lens to condense the light issued from the light source; this is not the sole case of the present invention and the light issued at a specified angle of radiation from the light source need not be condensed but it may simply be caused to strike the boundary surface between the prism and the metal film.

There is also no absolute need to provide the polarizing filter and this is particularly true in the case of using a laser light source since the light issued from the laser is already polarized.

In each of the foregoing embodiments, the number or concentration of the analytes contained in the sample is detected but this is not the sole case of the present invention and one may check to see if the liquid sample contains the analytes or not (i.e., if the analytes are in the liquid sample or not).

In each of the foregoing embodiments, an evanescent wave and surface plasmons are generated on the surface of the metal film and, furthermore, surface plasmon resonance is generated to form an enhanced electric field; however, this is not the sole case of the present invention and it may be applied to various approaches in which the intensity of enhancement varies with the angle of incidence of light on the surface where the enhanced electric field is to be formed (namely, the enhanced field varies only when light is incident at a specified angle). For example, the present invention is applicable to such an approach that a metal film and a SiO₂ film about 1 μm thick are superposed on the prism and that light incident at a specified angle is resonated within the SiO₂ film to thereby form an enhanced electric field.

What is claimed is:

1. A probe chip for use in a sensing apparatus in which an analyte contained in a liquid sample is labeled with a fluorescent material and light is caused to strike a detection surface at a specified angle of incidence to generate an enhanced field which enhances fluorescence from the fluorescent material to detect the analyte, comprising:
a prism;
a metal film provided on a surface of the prism and which has provided on its surface a first specifically binding material that specifically binds to the analyte; and
a channel substrate that is provided on a side of the prism and which has formed therein a channel for supplying the liquid sample to the metal film by causing the liquid material to travel from a beginning end portion to a terminal end portion, the channel being formed in such a way that a zone from a point between the beginning end portion and the metal film to a position of contact with the metal film separates into a first branch and a second branch that has an area where a second specifically binding material that is labeled with the fluorescent material and which specifically binds to the analyte is placed;
wherein the liquid sample traveling through the first branch is caused to reach the metal film, after which the liquid sample traveling through the second branch is caused to reach the metal film.

2. The probe chip according to claim 1, wherein the channel substrate has a first control valve that controls flow of the liquid sample through the first branch and a second control valve that controls flow of the liquid sample through the second branch.

3. The probe chip according to claim 1, wherein the channel causes the liquid sample to travel through the second branch for a longer time than through the first branch.

4. The probe chip according to claim 3, wherein the second branch is shaped to have irregularities.

5. The probe chip according to claim 3, wherein the second branch has an area somewhere in a zone from the beginning end portion to the position of contact with the metal film that is narrower than other areas.

6. The probe chip according to claim 3, wherein the second branch has a greater channel length than the first branch.

7. The probe chip according to claim 3, wherein a liquid-repelling member is provided between the first branch and the second branch.

8. The probe chip according to claim 1, wherein the enhanced field is an electric field enhanced by surface plasmon resonance.

9. A sensing apparatus comprising:
the probe chip according to claim 1;
a probe chip support means for supporting the probe chip;
a light source for issuing light;
an optical unit for incident light by which the light issued from the light source is launched into the prism at such an angle that it is totally reflected on a boundary surface between the prism and the metal film; and
a light detecting means that is provided in a face-to-face relationship with that surface of the metal film that is away from the prism for detecting light that is generated in neighborhood of the metal film.

10. The sensing apparatus according to claim 9, wherein the light detecting means first detects light generated in neighborhood of the metal film that has been only supplied with the liquid sample from the first branch and then detects light generated in neighborhood of the metal film that has been supplied with the liquid sample from the second branch.

11. A sensing apparatus in which an analyte contained in a liquid sample is labeled with a fluorescent material and light is caused to strike a detection surface at a specified angle of incidence to generate an enhanced field which enhances fluorescence from the fluorescent material to detect the analyte, comprising:
a light source for issuing light;
a prism;
a metal film provided on a surface of the prism and which has provided on its surface a first specifically binding material that specifically binds to the analyte;
a sample holder by which the liquid dripped over the metal film is held on the metal film;
an optical unit for incident light by which the light issued from the light source is launched into the prism at such an angle that it is totally reflected on a boundary surface between the prism and the metal film;
a light detecting means that is provided in a face-to-face relationship with that surface of the metal film that is away from the prism for detecting light that is generated in neighborhood of the metal film;
a first receptacle for containing the liquid sample;
a second receptacle for containing a second specifically binding material that is labeled with the fluorescent material and which specifically binds to the analyte;
a dispensing means for dispensing the liquid sample on the metal film; and
a control means that controls the operations of the light detecting means and the dispensing means;
wherein the control means causes the dispensing means to dispense the liquid sample in the first receptacle on the metal surface and also causes the light detecting means to detect the light generated in neighborhood of the metal film on which the liquid sample in the first receptacle has been dispensed, after which the control means causes the dispensing means to dispense the liquid sample into the second receptacle, mix the liquid sample with the second specifically binding material to obtain a mixture and dispense the mixture on the metal film, and also causes the light detecting means to detect the light generated in neighborhood of the metal film on which the mixture has been dispensed.

12. The sensing apparatus according to claim 11, wherein the enhanced field is an electric field enhanced by surface plasmon resonance.

13. The sensing apparatus according to claim 11, further includes a computing means for computing a concentration of the analyte in the liquid sample based on a result of detection by the light detecting means.

14. A method of detecting substances comprising:
a metal film providing step in which a metal film having on a surface thereof a specifically binding material that specifically binds to an analyte is provided;
a first liquid sample feeding step in which a liquid sample that is not labeled with the fluorescent material is brought into contact with the surface of the metal film;
a first light-detecting step in which when another surface of the metal film is irradiated with light at a specified angle of incidence as the surface of the metal film is contacted by the liquid sample that is not labeled with the fluorescent material so as to generate an enhanced field, the light being generated in neighborhood of the surface of the metal film is detected;
a mixing step in which the liquid sample is mixed with a second specifically binding material that is labeled with the fluorescent material and which specifically binds to the analyte to bind the analyte and the second specifically binding material so that the analyte is labeled with the fluorescent material;
a second liquid sample feeding step in which the liquid sample mixed in the mixing step that contains the analyte as labeled with the fluorescent material is brought into contact with the surface of the metal film;
a second light-detecting step in which when another surface of the metal film is irradiated with light at the specified angle of incidence as the surface of the metal film is contacted by the liquid sample that contains the analyte as labeled with the fluorescent material so as to generate an enhanced field, the light being generated in neighborhood of the surface of the metal film is detected; and
a substance detecting step in which the analyte in the liquid sample is detected based on a first value detected in the first light-detecting step and a second value detected in the second light-detecting step.

15. The method according to claim 14, further includes a computing step in which a concentration of the analyte in the liquid sample is computed based on a difference between the first value detected in the first light detecting step and the second value detected in the second light detecting step.

16. The method according to claim 14, wherein the enhanced field is an electric field enhanced by surface plasmon resonance.
